(19) United States
(12) Patent Application Publication
(10) Pub. No.: US 2008/0099508 A1
(43) Pub. Date: May 1, 2008

(54) DISPENSER FOR DISPENSING LIQUID

(76) Inventors: Seo-ho SON, Gyeongsan-si (KR); Myung-jin JIN, Paju-si (KR)

Correspondence Address: KED & ASSOCIATES, LLP, P.O. Box 221200, Chantilly, VA, 20153-1200, US

(21) Appl. No.: 11/749,246

(22) Filed: May 16, 2007

(30) Foreign Application Priority Data
Oct. 27, 2006 (KR) 10-2006-0105054

(51) Int. Cl. B67D 5/62; B65D 83/00; B67D 3/00

(52) U.S. Cl. 222/146.5; 222/504; 222/394

(57) ABSTRACT

A dispense for dispensing a liquid on a substrate is provided, including a nozzle through which to dispense on the substrate the liquid contained in a syringe, moving relative to the substrate, a valve unit for controlling dispensing of the liquid through the nozzle, including a valve which is opened and closed to control a flow of the liquid from the syringe to the nozzle and a valve controller controlling opening and closing operation of the valve, and a temperature-maintaining unit maintaining a temperature of the liquid passing the valve at a preset temperature. The present invention provides an advantage of dispensing a constant amount of liquid with no effect of a change in temperature on viscosity of the liquid.

### CROSS REFERENCE TO RELATED APPLICATION

This application claims the benefit of and priority from Korean Patent Application No. 2006-105054, filed on Oct. 27, 2006, which is hereby incorporated by reference for all purposes as if fully set forth herein.

### BACKGROUND OF THE INVENTION

1. Field of the Invention

The present invention relates to a dispenser for dispensing liquid, and more particularly to a dispenser for dispensing a constant amount of liquid on a glass substrate for use in manufacturing a liquid crystal panel.

2. Description of the Background Art

Flat panel displays encompass a growing number of technologies enabling video displays that are lighter and much thinner than traditional television and video displays that use cathode ray tubes, and are usually less than 10 cm (4 inches) thick. Flat panel displays requiring continuous refresh includes liquid crystal displays (LCDs), plasma displays, field emission displays (FEDs), organic light-emitting diode displays (OLEDs), surface-conduction Electron-emitter Displays (SEDs), nano-emissive display (NEDs, and electroluminescent displays (ELDs).

The liquid crystal display (LCD) is a thin, flat display device made up of any number of color or monochrome pixels arrayed in front of a light source or reflector. The liquid crystal display is in wide use because it uses very small amounts of electric power.

A liquid crystal panel for use in the liquid crystal display is manufactured as follows.

Patterns of a color filter and a common electrode are formed on a upper glass substrate. Patterns of a thin film transistor (TFT) and a pixel electrode are formed on a lower glass substrate opposite to the upper glass substrate. An alignment layer is deposited on the upper and lower glass substrates. The alignment layer is rubbed to make a crystal molecule between two alignment layers have a pretilt angle and a direction. An amount of sealant is dispensed to form a given pattern on the upper glass substrate to hermetically seal the upper and lower glass substrate. An amount of crystal liquid is dispensed on the lower glass substrate. Last, the upper and lower glass substrate is assembled to make the liquid crystal panel.

An amount of liquid crystal is dispensed to form a liquid crystal layer on a specific surface area of the lower glass substrate, which is defined by forming a given pattern of sealant on the upper glass substrate.

A dispenser for dispensing a liquid crystal forms the liquid crystal layer on the glass substrate, moving a nozzle through which to dispense liquid contained a syringe, relative to the glass substrate.

Liquid crystal, when dispensed through the nozzle, is susceptible to temperature change. The change in temperature change leads to change in viscosity of liquid crystal. The dispensing pressure, which is applied to liquid crystal, has to vary with the changing viscosity of liquid crystal. An amount of liquid crystal is larger than a preset amount of liquid crystal, when the same dispensing pressure is applied to the liquid crystal whose viscosity becomes low. This results in dispensing an uneven amount of liquid crystal depending upon the change in viscosity of liquid crystal.

The change in temperature of the liquid crystal may occur due to change of ambient temperature or high heat generated by repetitious opening and closing operation of a valve.

### SUMMARY OF THE INVENTION

Therefore, an object of the present invention is to provide a dispenser for dispensing a liquid, capable of dispensing a constant amount of liquid with no effect of a change in temperature on viscosity of the liquid.

According to an aspect of the present invention, there is provided a dispense for dispensing a liquid on a substrate, including a nozzle through which to dispense on the substrate the liquid contained in a syringe, moving relative to the substrate, a valve unit for controlling dispensing of the liquid through the nozzle, including a valve which is opened and closed to control a flow of the liquid from the syringe to the nozzle and a valve controller controlling opening and closing operation of the valve, and a temperature-maintaining unit maintaining a temperature of the liquid passing the valve at a preset temperature.

The temperature-maintaining unit may include a sensor measuring a temperature of the valve, a heat-adjusting unit absorbing heat from or generating and applying heat to the valve, and a temperature-maintaining controller controlling the heat-adjusting unit to allow the valve to maintain the preset temperature through comparison of a temperature measured by the sensor with the preset temperature.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view illustrating a configuration of a dispenser for dispensing a liquid according to an embodiment of the present invention;

FIG. 2 is a view illustrating an embodiment of a valve of FIG. 1;

FIG. 3 is a cross-sectional view illustrating a temperature-maintaining unit of FIG. 1; and

FIG. 4 is a perspective view illustrating the disassembled temperature-maintaining unit of FIG. 3

### DETAILED DESCRIPTION OF THE ILLUSTRATED EMBODIMENTS

Reference will now be made in detail to the preferred embodiment of the present invention, an example of which is illustrated in the accompanying drawings.

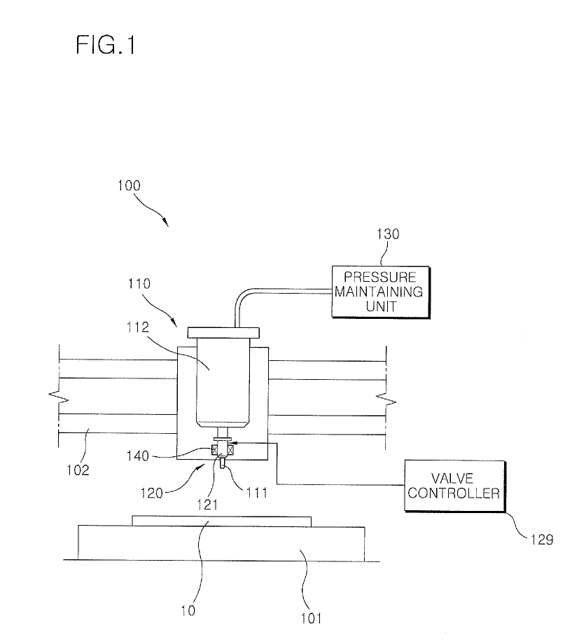

FIG. 1 is a view illustrating a configuration of a dispenser for dispensing a liquid according to an embodiment of the present invention.

Referring to FIG. 1, the dispenser 100 for dispensing a liquid according to the embodiment of the present invention includes a nozzle 111 through which to dispense the liquid such as a liquid crystal.

The liquid contained in a syringe 112 is dispensed on a substrate 10 through the nozzle 111 which is moved relative to the substrate 10. The nozzle 111 is provided on a dispensing head unit 110 which is supported by a head supporting frame 102 which is movably provided in one direction on a main body 101. The dispensing heading unit 110 is provided to be movable in the direction opposite to the direction in which the head supporting frame 102 is movable. This makes it possible for the nozzle 111 to move relative to the substrate 10.

The syringe 112, which contains the liquid to be dispensed through the nozzle 111, may be provided to the dispensing head unit, in such a manner that the syringe 112 is connected, directly or through a tube, to the nozzle 111. The pressure-maintaining unit 130 may be provided to the syringe 112. The pressure-maintaining unit 130 supplies a gas to the syringe 112 to maintain a constant pressure within the syringe 112 and thereby enable a constant amount of the liquid to be dispensed through the nozzle 111.

A valve unit 120 is provided to control a flow of the liquid through the nozzle 111. The valve unit 120 does not allow the liquid to be dispensed through the nozzle 111 is when stopping dispensing the liquid on the substrate. The valve unit 120 allows a constant amount of liquid to be dispensed through the nozzle 111 when dispensing the liquid.

The valve unit 120 includes a valve 121. The valve 121, provided between the syringe 112 and the nozzle 111, opens or shuts to control the flow of the liquid from the syringe 112 to the nozzle 111. A valve controller 129 controls operation of the valve 121. The valve controller 129 may include a controlling unit controlling operation of the whole dispenser 100.

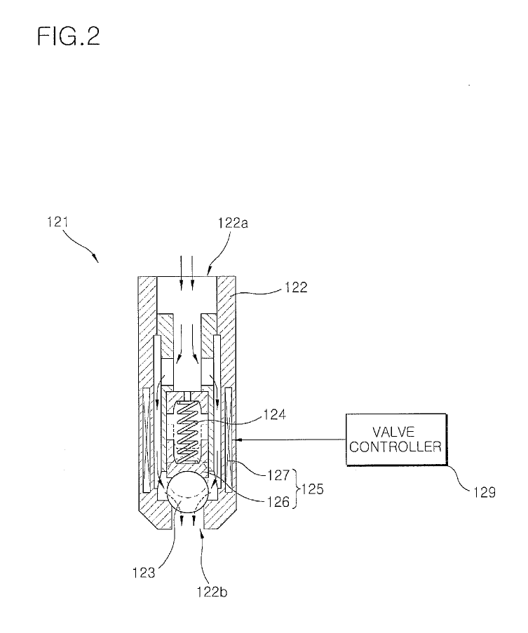

The valve 121 includes a commercially-available valve which opens or shuts to control a flow of liquid, gas, air etc passing through it, as shown in FIG. 2.

The valve 121, as shown in FIG. 2, includes a main body 122, a moving member 123, an elastic member 124, and a driver 125.

An inlet 122a, connected to an outlet of the syringe 112 for the flow of liquid from the syringe 112 to the valve 121, is formed on one end of the main body 122. An outlet 122b, connected to an inlet of the nozzle 111 for the flow of liquid from the valve 121 to the nozzle 111, is formed on the other end of the main body 122.

The moving member 123 slides up and down within the main body 122 to open and close the outlet 122b. That is, the moving member 123 opens and closes a passage for the liquid to flow through. This makes it possible to control dispensing of the liquid through the nozzle 111.

The elastic member 124 applies an elastic force to the moving member 123 and as a result the moving members is moved to close the outlet 122b. The outlet 122b remains closed with the moving member 123 until the driver 125 moves the moving member 123.

When the driver 125 applies a driving force to the moving member 123 which closes the outlet 122b, the moving member is moved to open the outlet 122b. The moving member 123 is moved by an electromagnetic force generated by electric current which the valve controller 129 applies to the driver 125.

The driver 125 includes a flange 126 fixed to the moving member but slidable within the main body 122 and a wire coil 127 around the flange 126. The flange 126 has magnetism and therefore is movable by electromagnetic force generated by the wire coil 127. When the valve controller 129 applies electric current to the wire coil 127, the wire coil 127 generates an electromagnetic force by which the moving member 123 fixed to the flange 126 is moved to open the outlet 122b.

High heat may be generated due to the valve 121's repetitive operation of opening and closing the outlet 122b. This high heat may be transferred to the liquid, thereby causing a change in temperature of liquid. The change in liquid temperature leads to a change in viscosity of liquid. The change in liquid viscosity may be due to ambient temperature around the valve 121. The change in liquid viscosity leads to a change in a dispensing pressure to be applied to the liquid. This prevents a constant amount of liquid from being dispensed. This phenomenon occurs more frequently in case of dispensing a very small of liquid.

The temperature-maintaining unit 140 according to the embodiment of the present invention is provided to prevent this phenomenon. The temperature-maintaining unit 140 maintains a temperature of the liquid introduced into the valve 121 at a preset temperature. As a result, the dispensing pressure is constantly applied to the liquid. This makes it possible to dispense a constant amount of liquid, especially when constantly dispensing a small amount of liquid.

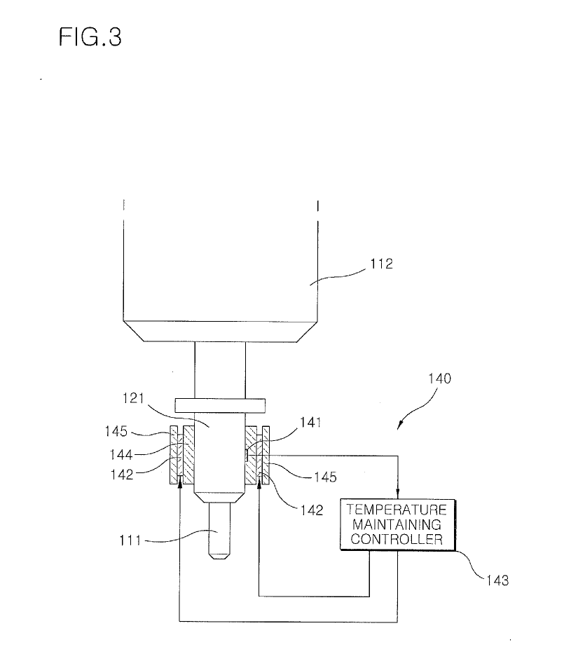

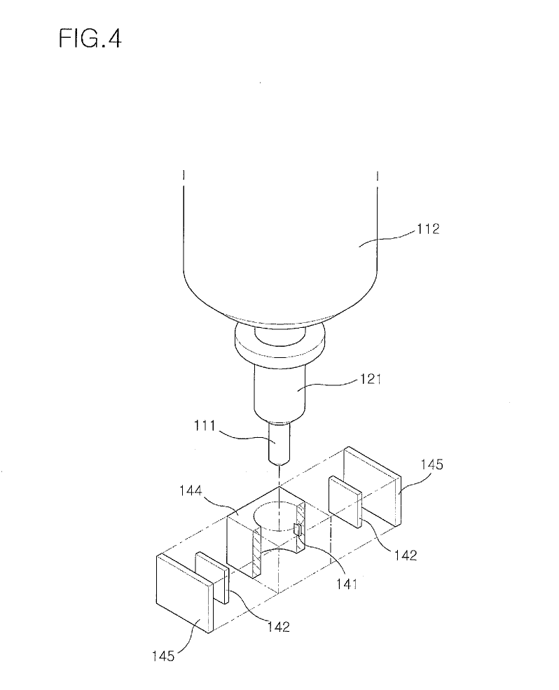

The temperature-maintaining unit 140 may be configured as shown in FIGS. 3 and 4. The temperature-maintaining unit 140 as shown in FIGS. 3 and 4, includes a sensor 141, a heat-adjusting unit 142 and a temperature-maintaining controller 143.

The sensor 141 serves to measure a temperature of the valve 121. The sensor 141 is attached to a surface of the valve 121 to measure a temperature of the surface of the valve 121 which is raised by heat generated within the valve 121. The sensor 141 may include a thermistor. Data on the temperature measured by the sensor 141 is provided to the temperature-maintaining controller 143 controlling the heat-adjusting unit 142.

The heat-adjusting unit 142 absorbs heat as a heat sink and generates heat to the valve 121 as a heat source. The heat-adjusting unit 142 may include a thermoelectric device. The thermoelectric device is capable of absorbing and generating heat using the Peltier effect which is a creation of a heat difference from an electric voltage. The Peltier effect occurs when a current is passed through two dissimilar metals or semiconductors (n-type and p-type) that are connected to each other at two junctions (Peltier junctions). The current drives a transfer of heat from one junction to the other: one junction cools off while the other heats up; as a result, the effect is often used for thermoelectric cooling.

According to the embodiment of the present invention, heat generated within the valve is absorbed, or heat is generated and applied to the valve 121 using the Peltier effect. The temperature-maintaining controller 143, when using a thermoelectric device as the heat-adjusting unit 142, changes not only a direction of electric current to enable the thermoelectric device to switch between absorbing heat and generating heat, but also an amount of electric current to control an amount of absorbed heat or an amount of generated heat. The temperature-maintaining controller 143 receives data on the measured temperature from the sensor 141 and controls the thermoelectric device based on the data to maintain the temperature of the valve at a preset temperature.

The temperature-maintaining controller 143 compares the temperature measured by the sensor 141 with the preset temperature and compensates for a temperature difference to maintain the preset temperature. When the measured temperature is determined as higher than the preset temperature, the temperature-maintaining controller applies electric current to the thermoelectric device to enable the thermoelectric device to absorb the heat generated within the valve 121, but an amount of electric current which corresponds to a difference between the measured temperature and the preset temperature. When the measured temperature is determined as lower than the preset temperature, the temperature-maintaining controller 143 applies electric current to the thermoelectric device in an opposite direction to generate heat to the valve 121 but an amount of electric current which corresponds to a difference between the measured temperature and the preset temperature.

The temperature-maintaining controller 143 discontinues to apply electric current when the sensor 141 senses that the temperature of the valve 121 reaches the preset temperature. In this way, the temperature-maintaining controller 143 continues to perform the feedback control to maintain the temperature of the valve 121 at the preset temperature.

A thermal-conductivity member 144 may be further provided between the heat-adjusting unit 142 and the valve 121. The thermal-conductivity member 144 expedites transfer of the heat generated within the valve to the heat-adjusting unit 142 and transfer of the heat generated by the heat-adjusting unit 142 to the valve 121. The thermal-conductivity member 144 also serves to support the valve 121.

A heat sink 145 may be further provided to an outside surface of the heat-adjusting unit 142. The heat sink 145 dissipates outside the heat which the heat-adjusting unit 142 absorbs from the valve 121. The heat sink 145 has a surface area as large as possible to increase a heat-dissipating effect. For example, the heat sink 145 may have an air passage inside. Air flows from one end of the passage to the other end. The heat sink 145 may have a base with one or more flat surfaces and an array of comb or fin-like protrusions to increase the heat sink's surface area contacting the air.

Operation of the dispenser 100 according to the embodiment of the present invention is now described.

The pressure-maintaining unit 130 is connected to the syringe 112 to maintain a pressure within the syringe 112 at a given pressure. When dispensing a constant amount of liquid on the substrate 10 through the nozzle 111, the valve controller 129 of the valve unit 120 opens the valve 121 to allow the liquid to flow from the syringe 112 to the nozzle 111. When finishing dispensing the constant amount of liquid, the valve controller 129 of the valve unit 120 closes the valve 121 to prevent the liquid from flowing from the syringe 112 to the nozzle 111.

Temperature of the valve 121 is increased due to the repetitive opening and closing operation or an increase in ambient temperature. At this point, the temperature-maintaining unit 140 maintains the temperature of the valve 121 at the preset temperature through comparison of the temperature measured by the sensor 141 with the preset temperature and compensation for a temperature difference. When the measured temperature is determined as high than the preset temperature, the temperature-maintaining controller 143 enables the heat-adjusting unit 142 to absorb heat generated with the valve 121 to a degree which reduces the temperature of the valve 121 to the preset temperature. At this point, the heat generated within the valve 121 is absorbed by the heat-adjusting unit 142 through the thermal-conductivity member. 144 The heat absorbed by the heat-adjusting unit 142 is dissipated into air through the heat sink 145.

When the measured temperature is determined as low than the preset temperature, the temperature-maintaining controller 143 enables the heat-adjusting unit 142 to generate and apply heat to the valve 121 to a degree which increase the temperature of the valve 121 to the preset temperature. At this point, the heat generated by the heat-adjusting unit 142 is transferred through the thermal-conductivity member 144 to the valve 121, thereby heating the valve 121.

As above described, the temperature-maintaining controller 143 enables the heat-adjusting unit 142 to cool or heat the valve 121 until the sensor 141 determines if the temperature of the valve 121 reaches the preset temperature and to discontinue to cool or heat the valve 121 when the sensor 141 determines that the temperature of the valve 121 reaches the preset temperature, The feedback control of the heat-adjusting unit 142 is performed by the temperature-maintaining controller 143. The present invention provides an advantage of dispensing a constant amount of liquid regardless of change in viscosity of the liquid, even when dispensing a very small amount of liquid on the substrate.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A dispenser for dispensing a liquid on a substrate, comprising:
a nozzle through which to dispense on the substrate the liquid contained in a syringe, moving relative to the substrate;
a valve unit for controlling dispensing of the liquid through the nozzle, comprising:
a valve which is opened and closed to control a flow of the liquid from the syringe to the nozzle; and
a valve controller controlling opening and closing operation of the valve; and
a temperature-maintaining unit maintaining a temperature of the liquid passing the valve at a preset temperature.

2. The dispenser for dispensing a liquid on a substrate according to claim 1, wherein the temperature-maintaining unit comprises:
a sensor measuring a temperature of the valve;
a heat-adjusting unit absorbing heat generated within the valve or generating and supplying heat to the valve; and
a temperature-maintaining controller controlling operation of the heat-adjusting unit to maintain the temperature of the valve at a preset temperature by comparing temperature measured by the sensor with the preset temperature.

3. The dispenser for dispensing a liquid on a substrate according to claim 2, wherein the heat-adjusting unit is a thermoelectric device.

4. The dispenser for dispensing a liquid on a substrate according to claim 3, wherein a thermal-conductivity member is further provided between the valve and the heat-adjusting unit.

5. The dispenser for dispensing a liquid on a substrate according to claim 3, wherein the temperature-maintaining unit further comprises a heat sink dissipating the heat which the heat-adjusting unit absorbs from the valve.

6. The dispenser for dispensing a liquid on a substrate according to claim 1, further comprising a pressure-maintaining unit maintaining a pressure within the syringe at a constant pressure.

7. The dispenser for dispensing a liquid on a substrate according to claim 1, wherein the valve comprises:
a main body of which one end has an inlet connected to an outlet of the syringe for the flow of liquid flowing from the syringe to the valve, the other end has an outlet connected to an inlet of the nozzle for the flow of the liquid flowing from the valve to the nozzle, and which has inside a passage for the liquid to flow through and to connect between the inlet of the valve and the outlet of the valve,
a moving member provided to be movable within the valve to open and close the outlet of the valve;
an elastic member applying an elastic force to the moving member to close the outlet of the valve; and
a driver applying to the moving member an electromagnetic force generated by electric current which the valve controller applies to the driver to open the outlet of the valve.

8. The dispenser for dispensing a liquid on a substrate according to claim 1, wherein the liquid is a crystal liquid.

9. The dispenser for dispensing a liquid on a substrate according to claim 2, wherein the liquid is a crystal liquid.

10. The dispenser for dispensing a liquid on a substrate according to claim 3, wherein the liquid is a crystal liquid.

11. The dispenser for dispensing a liquid on a substrate according to claim 4, wherein the liquid is a crystal liquid.

12. The dispenser for dispensing a liquid on a substrate according to claim 5, wherein the liquid is a crystal liquid.

13. The dispenser for dispensing a liquid on a substrate according to claim 6, wherein the liquid is a crystal liquid.

14. The dispenser for dispensing a liquid on a substrate according to claim 7, wherein the liquid is a crystal liquid.
